(19) United States
(12) Patent Application Publication
(10) Pub. No.: US 2011/0024573 A1
(43) Pub. Date: Feb. 3, 2011

(54) EXTENDED WINGLET WITH LOAD BALANCING CHARACTERISTICS

(75) Inventors: Philip S. Kirk, Encinitas, CA (US); Robert E. Olson, Kirkland, WA (US)

Correspondence Address: DWC LAW FIRM, P.S., P.O. BOX 3041, SEATTLE, WA, 98114-3041, US

(73) Assignee: Quiet Wing Technologies, Inc., Kirkland, WA (US)

(21) Appl. No.: 12/774,697

(22) Filed: May 5, 2010

Related U.S. Application Data
(60) Provisional application No. 61/176,086, filed on May 6, 2009.

(51) Int. Cl. B64C 23/00

(52) U.S. Cl. 244/199.4

(57) ABSTRACT

A winglet and methods of operating an aircraft using the winglet. In some embodiments, the winglet can be mounted to the wingtip of an aircraft and has three segments or portions, namely, a mounting portion, an upwardly extending portion, and a reverse portion, or a portion that extends in an inboard direction.

### CROSS REFERENCE TO RELATED APPLICATION(S)

This application claims the benefit of U.S. provisional patent application No. 61/176,086, filed May 6, 2009, which is incorporated herein by reference in its entirety.

### BACKGROUND OF THE INVENTION

1. Field of the Invention

The present invention relates generally to winglets for increasing aircraft fuel efficiency.

2. Description of Related Art

Winglets are commonly utilized on aircraft wing tips and often comprise upwardly extending extensions of the wing tips. Winglets can increase wing efficiency generally by increasing the effective length of the wings. That is, for example, winglets block the communication of air at the tips of the wings so that the lift can extend further out on the wing.

Although winglets function to increase lift, they can also result in increased wing bending and shear loads against the outboard portion of wings on which they are installed. This can be problematic, as the wing structures of aircrafts are often designed only to carry the load of an unmodified wing with limited margin of safety and the increased bending and shear loads could necessitate structural modifications. Such structural modification requirements can negate economic benefit offered by the winglet.

U.S. Pat. No. 5,407,153 discloses a wing modification kit which enables aerodynamically designed winglets to be utilized for a particular aircraft while partly mitigating the need for structural modifications. However, such wing modifications still require time and expense beyond installation of the winglet.

### BRIEF SUMMARY OF THE INVENTION

In some embodiments of the present invention, a winglet comprises a mounting segment, upwardly extending segment (main winglet panel), and reverse segment, the reverse segment being the last segment of the winglet. The reverse segment extends a lifting surface of the winglet beyond an end portion of the upwardly extending segment. The reserve segment is configured to generally produce downward (negative) lift during flight and can have a negative camber.

In some embodiments, among the mounting segment, upwardly extending segment and reverse segment, only the reverse segment generally produces downward lift during flight. The reverse segment can extend in an inboard direction away from a top portion of the upwardly extending segment and can be configured to be disposed in approximately parallel alignment with a wing of an aircraft to which the winglet is mounted. In some embodiments, an inboard end portion of the reverse segment extends inwardly at an inclined angle of about five degrees from horizontal. Also, the chord length of each airfoil section of the reverse segment can be less than all chord lengths of the upwardly extending segment and the mounting segment.

### BRIEF DESCRIPTION OF THE SEVERAL VIEWS OF THE DRAWING(S)

FIG. 1 is a front elevational view of an aircraft fitted with prior art winglets.

FIG. 2 is a side elevational view of an airplane wing modified with a prior art winglet assembly.

FIG. 3 is a front elevational view of a prior art winglet assembly.

FIG. 4 is a front elevational view of an embodiment of a winglet of the present invention, looking aft toward the winglet.

FIG. 5 is a side elevational view of the winglet of FIG. 4, as viewed from a position inboard of the winglet.

FIG. 6 is a top plan view of the winglet of FIGS. 4 & 5.

FIG. 7 is a side elevational view of the winglet of FIG. 6, as viewed from an outboard position.

FIG. 8 is a simplified front elevational view, looking aft, of an aircraft wing fitted with the winglet of FIG. 4 of the present invention, also illustrating example relative force vectors acting on the wing and winglet during flight.

FIG. 9 is the front elevational view of FIG. 4, further depicting airfoil sections lines 9A-9A through 9E-9E.

FIGS. 9A-9E depict airfoil sections of the winglet of FIG. 9, showing cross-sectional geometry of the winglet along corresponding section lines 9A-9A through 9E-9E of FIG. 9.

### DETAILED DESCRIPTION OF PREFERRED EMBODIMENTS

In the following description, certain specific details are set forth in order to provide a thorough understanding of various embodiments of the invention. However, upon reviewing this disclosure one skilled in the art will understand that the invention may be practiced without many of these details. In other instances, well-known structures and methods associated with aircraft wings and winglet structures and related operations have not been described in detail to avoid unnecessarily obscuring the descriptions of the embodiments of the invention.

Various embodiments of the present invention are described and illustrated in the context of application to example commercial aircraft, such as, for example, without limitation, the BOEING 737-300/400/500, BOEING 747-200/300/400, and AIRBUS A319, 320. However, one skilled in the art will understand after reviewing the present disclosure, that the present invention may have applicability in a variety of different types and models of aircraft.

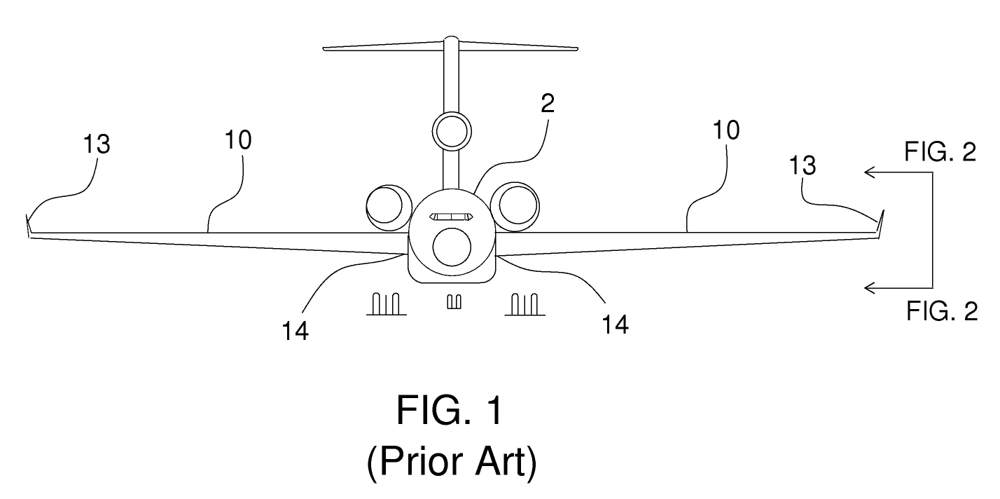

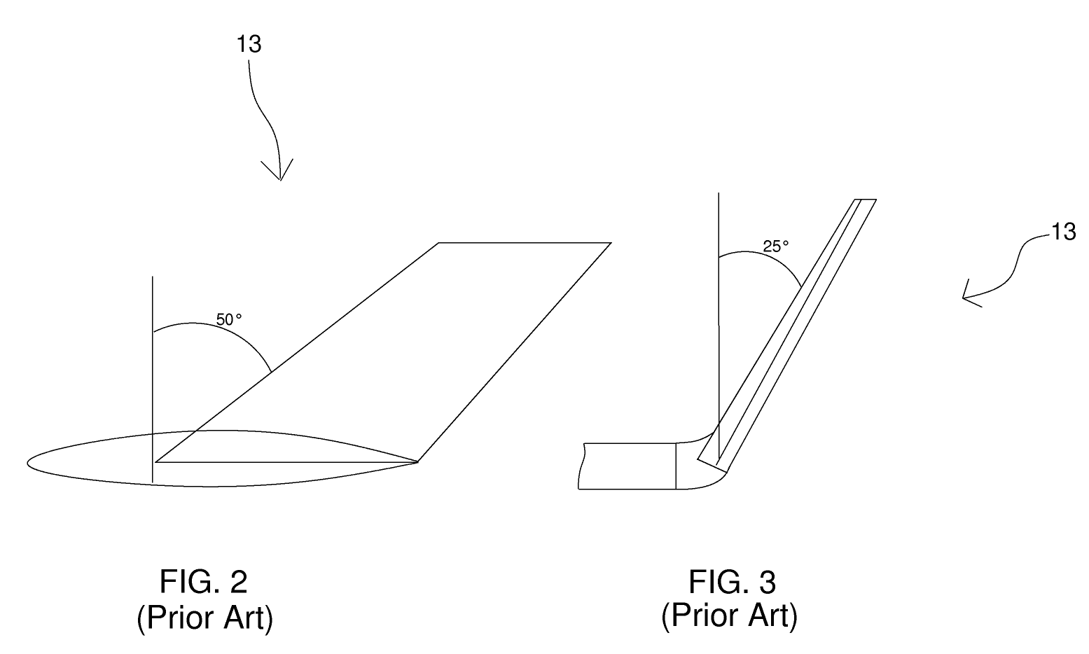

Conventional winglets, such as, for example, the prior art winglets 13 shown in FIGS. 1-3, are often used by being mounted or attached to the tip of each wing 10 of an aircraft 2, and such installation can be made after manufacture of the aircraft. The prior art winglet 13 is mounted with an upwardly extending main section which can cant outward from the wing. The upwardly extending section can be inclined, for example, about 25 degrees from vertical, as shown in FIG. 3. The outward cant of the winglet aids in eliminating wing flutter, while increasing wing load.

However, as disclosed in U.S. Pat. No. 5,407,153, which is incorporated herein by reference in its entirety, wings 10 of the aircraft 2 can have a small load margin of safety, insufficient to bear additional bending moment and shear loads introduced by installation of the winglet 13, unless structural design changes are implemented to the aircraft. The invention disclosed in U.S. Pat. No. 5,407,153 provides modifications to existing ailerons and flaps in order to accommodate the addition of a winglet 13 to avoid expenses that would otherwise be required to increase the load bearing capacity of the wing 10. However, even that solution still requires the additional time and expense associated with the aileron and flap modifications.

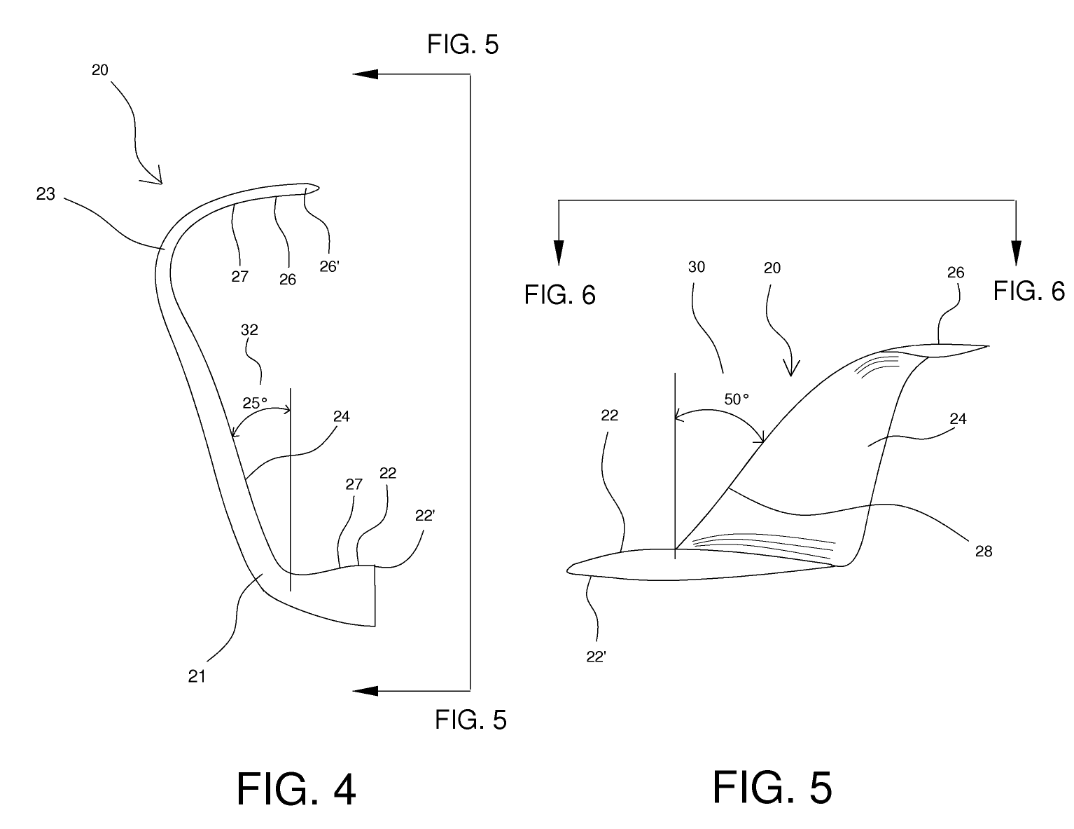

Referring to FIG. 4, an embodiment of the winglet 20 of the present invention is shown having generally three segments, connected or formed together with regions of curvature 21, 23 between the segments or formed as part of the segments. The segments are a mounting segment 22, main winglet panel 24 and a reverse segment 26. The mounting segment 22 extends briefly outboard from a wingtip of an aircraft, the winglet panel 24 extends generally upward at an inclination angle, and the reverse segment 26 extends generally inboard toward the airplane fuselage.

Referring to FIG. 4, the mounting segment 22, including an inboard portion 22′ thereof, can be installed or mounted to the wing tip portion of an aircraft 2 to secure the winglet 20 to the aircraft wing 10. When the winglet 20 is secured to an aircraft wing 10, the winglet panel 24 can cant outward away from the aircraft 2 at an inclination angle 32 of about twenty-five (25) degrees from vertical. In other embodiments, the inclination angle 32 is more than twenty-five (25) degrees or less than twenty-five (25) degrees from vertical.

Referring to FIG. 5, in some embodiments of the present invention, the winglet panel 24 also has a leading edge 28 that leans aft and rises at a leading edge angle 30. The leading edge angle 30 can be about fifty (50) degrees from vertical, with an upper portion of the leading edge 28 being disposed aft of a lower portion of the leading edge 28.

Referring to FIG. 4, the reverse segment 26, extends inwardly, and can have an inboard end portion 26′ that is generally horizontally oriented, or otherwise oriented in almost parallel alignment with a wing 10 of the aircraft 2. In some embodiments of the present invention, the inboard end portion 26′ of the reverse segment 26 extends inwardly at a positive angle of about five (5) degrees above a horizontal line.

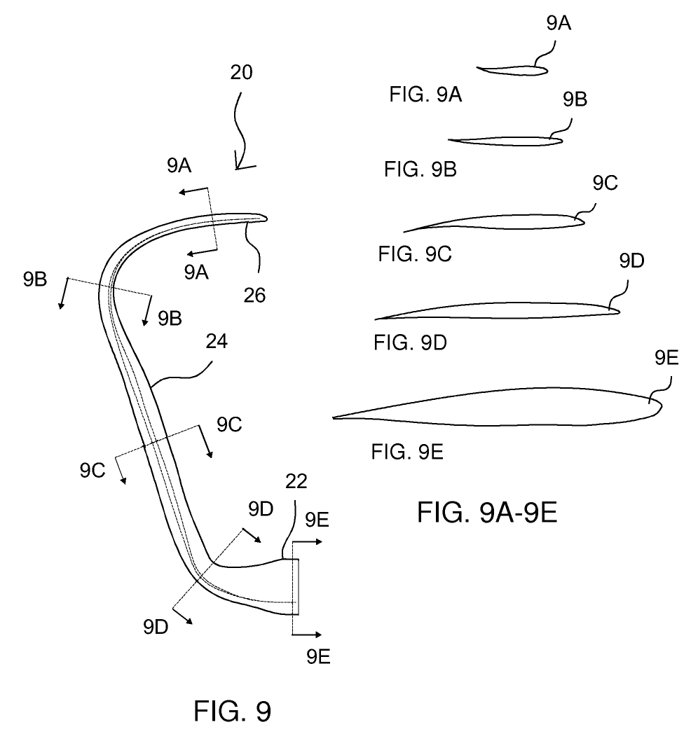

FIG. 9 depicts an example embodiment of the winglet 20 of the present invention, showing a plurality of locations of sample airfoil sections of the winglet 20, being marked as 9A-9A through 9E-9E, to correspond to the cross-sectional geometries 9A-9E depicted in FIGS. 9A-9E. For some embodiments of the present invention, in the reverse segment 26 of the winglet 20, a mean camber line for each airfoil section (such as, for example, airfoil section 9A) can be below a chord line of the same airfoil section, or can reflect a negative camber, and can also be otherwise configured to produce downward lift (such as at zero angle of attack), as will be appreciated by those skilled in the art after reviewing this disclosure. Such geometric characteristics are generally illustrated in FIG. 9A. In some embodiments, the illustrated airfoil section 9B in the region of curvature 23 (See, FIGS. 4 & 9) can also have a negative component of lift; however, the remainder of the illustrated airfoil sections, sections 9C-9E, are not configured to produce the downward lift associated with the reverse segment 26. For example, the airfoil section geometry can be substantially similar throughout the winglet 20, but is turned throughout the winglet 20 due to the lateral curvature of the winglet 20 shown in FIGS. 4 & 9, until the inside surface 27 that faced downward at the reverse segment 26 faces upward at the mounting segment 22. As such, the winglet panel 24, or a major portion thereof, is configured to produce at least an upward component of lift, rather than the negative lift reflected in the reverse segment 26 (as will be described in further detail below) and the mounting segment 22 is configured to produce generally positive lift.

In some embodiments of the present invention, the chord lengths of the airfoil sections of the winglet 20 decrease throughout the winglet 20 from the tip (at the reverse segment 26) to the inboard portion 22′ (at the mounting segment 22).

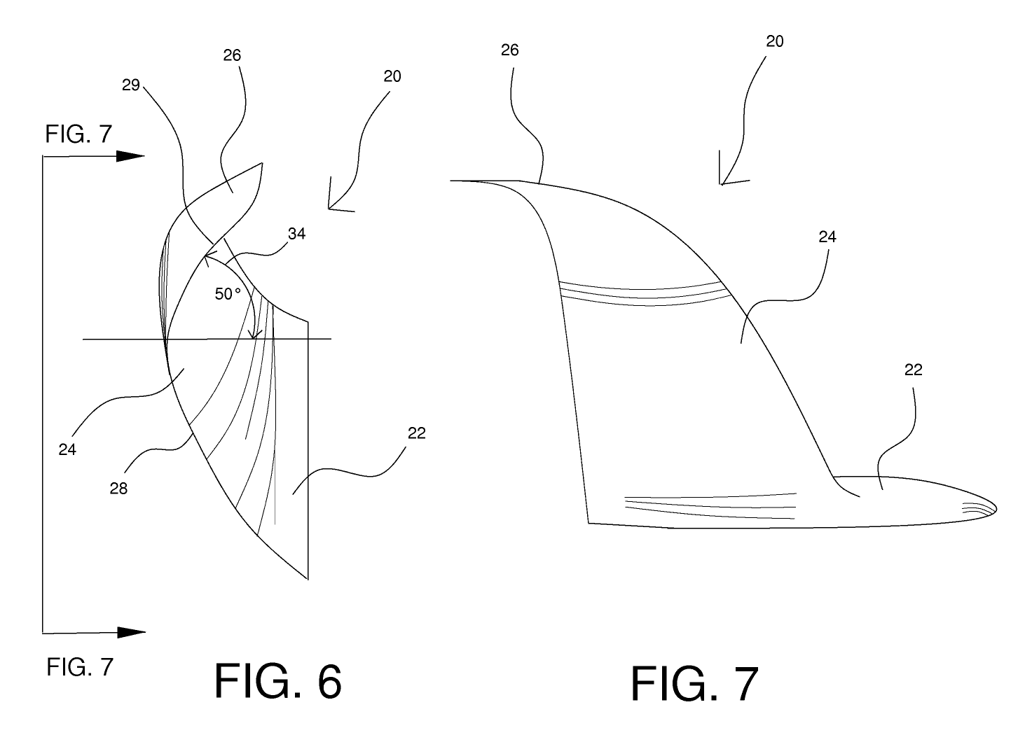

Referring to FIG. 6, in some embodiments of the present invention, a leading edge 29 of the reverse segment 26 slopes aft from the leading edge 28 of the winglet panel 24 toward the end portion of the reverse segment 26. The leading edge 29 of the reverse segment 26 can have a horizontal slope at an angle 34 of about fifty (50) degrees away from a lateral orientation. That slope can be greater than fifty (50) degrees in some embodiments of the present invention or less than fifty (50) degrees for other embodiments of the present invention.

The reverse segment 26 can provide, without limitation, at least the following beneficial features:

The reverse segment 26 can extend the “lifting” surface of the wing 10 over a longer distance than for either the basic wing 10 or the main winglet panel 24. This longer lifting surface can extend and weaken the vortex sheet that is shed from the trailing edge of the wing over a greater distance. The extension of the vortex sheet can reduce induced drag on the wing 10, this being the drag that is directly attributable to the production of lift on the wing 10. The reduction in induced drag can more than offset any downward lift generated by airflow over the reverse segment 26.

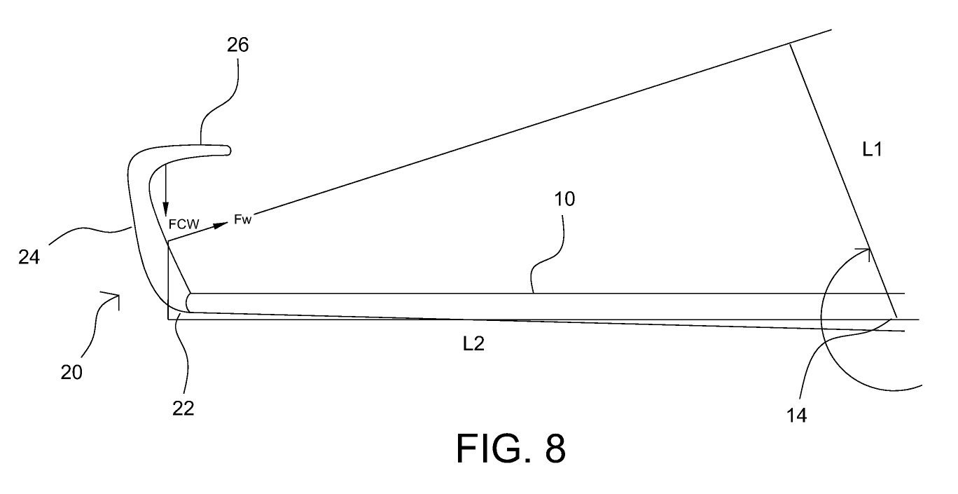

Also, as can be seen in FIG. 8, the main winglet panel 24 can produce lift in a direction to produce winglet load Fw, as represented by vector Fw in FIG. 8, to increase the wing bending loads over the major part of the wing 10, the load being the greatest at the wing root 14. However, the reverse segment 26 of the winglet 20 can have an associated force vector Fcw, as shown in FIG. 8, in a downward direction, and this reduces the bending loads on the wing 10. For example, a wing root bending moment due to the winglet 20 can be expressed as Fw×L1, with the force vector Fw and length L1 being illustrated in FIG. 8. However, the wing root bending moment can be decreased due to the downward lift of the reverse segment 26, the decrease being expressed as Fcw×L2, with the force vector Fcw and length L2 being illustrated in FIG. 8.

The benefits of the present invention are predicted to alleviate the necessity for any structural modifications to the aircraft, wing, ailerons or flaps in order to install and use the winglet 20 on various commercial aircraft, such as, without limitation, those described. Also, the predicted minimal effect on total lift of the wing 10 and winglet 20 will be experienced while induced drag is simultaneously reduced.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

The specific embodiments described herein are offered by way of example only, and the invention is to be limited only by the terms of the claims, along with the full scope of equivalents to which such claims are entitled.

What is claimed is:

1. A winglet attachable to an aircraft wing, the winglet comprising:
a mounting segment;
an upwardly extending segment; and
a reverse segment, the reverse segment extending a lifting surface of the winglet beyond an end portion of the upwardly extending segment and being configured to produce downward lift.

2. The winglet of claim 1 wherein among the mounting segment, upwardly extending segment and reverse segment, only the reverse segment is configured to produce downward lift.

3. The winglet of claim 1 wherein a surface of the reverse segment extends in an inboard direction away from the upwardly extending segment.

4. The winglet of claim 3 wherein a surface of the reverse segment is configured to be disposed in approximately parallel alignment with a wing of an aircraft to which the winglet is mounted.

5. The winglet of claim 4 wherein an inboard portion of the reverse segment extends inwardly at an inclined angle of about five degrees from horizontal.

6. The winglet of claim 1 wherein a chord length of the reverse segment is smaller than a chord length of the upwardly extending segment.

7. The winglet of claim 1 wherein a leading edge of the reserve segment is sloped aft.

8. A method of operating an aircraft comprising:
attaching a winglet to a wing of the aircraft, the winglet having a reverse segment that extends a lifting surface of the winglet past an end portion of an upwardly extending segment of the winglet;
generating upward lift using the at least one wing and at least a portion of the at least one winglet; and
simultaneously generating downward lift using at least a portion of the reverse segment of the winglet.

9. The method of claim 8 wherein the upwardly extending segment cants outward from the wing at an angle of about twenty-five degrees from vertical.

10. The method of claim 8 wherein the reverse segment extends in an inboard direction away from the upwardly extending segment of the winglet.

11. The method of claim 10 wherein the reverse segment has a leading edge that slopes aft from a point nearest the upwardly extending segment to a point near an inboard end portion of the reverse segment.

12. The method of claim 11 wherein the angle of the slope is about fifty degrees from lateral.

13. The method of claim 8 wherein an airfoil section of the reverse segment has a negative camber.

14. An aircraft wing having a winglet mounted to an outboard tip of the wing, the winglet comprising:
a first portion that extends generally horizontally outward from a tip of the wing;
a second portion that extends generally upward at an outward angle of cant; and
a third portion having a contour selected to generally produce downward lift.

15. The aircraft wing of claim 14 wherein the contour of the first portion is selected to generally produce upward lift.

16. The aircraft wing of claim 14 wherein airfoil sections in each of the first, second and third portions of the winglet are asymmetric.

17. The aircraft wing of claim 16 wherein the third portion comprises a negative camber and the first portion comprises a positive camber.

18. The aircraft wing of the claim 14 wherein the third portion comprises a sloped leading edge.

19. The aircraft wing of claim 14 wherein a chord length of an airfoil section of the third portion is less than all chord lengths of the second portion.

20. The aircraft wing of claim 14 wherein a chord length of an airfoil section of the second portion is less than all chord lengths of the first portion.
